(19) United States
(12) Patent Application Publication
(10) Pub. No.: US 2011/0154678 A1
(43) Pub. Date: Jun. 30, 2011

(54) DRYER

(75) Inventor: Ju Dong Lee, Incheon (KR)

(73) Assignee: Daewoo Electronics Corporation, Seoul (KR)

(21) Appl. No.: 12/649,406

(22) Filed: Dec. 30, 2009

(51) Int. Cl. F26B 11/02

(52) U.S. Cl. 34/130

(57) ABSTRACT

A dryer is disclosed. The dryer includes a cabinet, a drum rotatably disposed inside the cabinet, a front supporter disposed at an open side of the drum, a steam generator disposed inside the cabinet and generating steam, and a nozzle unit coupled to the front supporter and spraying the steam generated by the steam generator toward a plurality of regions inside the drum.

### BACKGROUND OF THE INVENTION

1. Field of the Invention

The present invention relates to a dryer and, more particularly, to a dryer that can preventing or remove wrinkles from laundry.

2. Description of the Related Art

A dryer is an electronic appliance that dries washed laundry using hot air.

Generally, the dryer includes a drum receiving laundry to be dried, a drive source driving the drum, a heater heating air flowing into the drum, and a blower unit suctioning or discharging air from the drum.

Such a dryer can be classified into an electric dryer and a gas dryer according to a heating manner, that is, the heater of the dryer. The electric dryer heats air using electric resistance heat, whereas the gas dryer heats air using heat by combustion of a gas.

When laundry is washed using water, wrinkles are generated in the laundry and are unlikely to be removed by the drying operation. Conventionally, it is necessary to perform a separate ironing operation to remove the wrinkles from the laundry. Therefore, there is a need to solve such problems of the conventional dryer.

### SUMMARY OF THE INVENTION

The present invention is conceived to solve the problems of the related art as described above, and an aspect of the invention is to provide a dryer capable of preventing or removing wrinkles from laundry.

According to one aspect of the invention, a dryer includes: a cabinet; a drum rotatably disposed inside the cabinet; a front supporter disposed at an open side of the drum; a steam generator disposed inside the cabinet and generating steam; and a nozzle unit coupled to the front supporter and spraying the steam generated by the steam generator toward a plurality of regions inside the drum.

The nozzle unit may be coupled to an upper portion of the front supporter.

The nozzle unit may be bifurcated into plural nozzles.

The nozzle unit may include a first nozzle connected to the steam generator; a second nozzle connected to the first nozzle and spraying the steam in a first direction; and a third nozzle connected to the first nozzle and spraying the steam in a second direction.

The first direction may be a front direction of a lower portion of the drum and the second direction may be a central direction of the lower portion of the drum.

The front supporter may be formed with an insertion hole into which the nozzle unit is inserted.

The nozzle unit may include a latch protruding from an outer periphery thereof, and the front supporter may include a through-hole through which the latch of the nozzle unit passes when the nozzle unit is inserted into the insertion hole. Here, the through-hole communicates with the insertion hole.

The nozzle unit may include a body having a greater size than a diameter of the insertion hole and supporting the nozzle unit inside the front supporter.

The second nozzle and the third nozzle may be formed within the body.

A distance between a lower surface of the latch and an upper surface of the body may correspond to a thickness of the front supporter.

The front supporter may include a positioning protrusion formed on an outer periphery thereof to position the nozzle unit such that the second nozzle faces in the first direction and the third nozzle faces in the second direction.

The positioning protrusion may be formed on an outer periphery of the insertion hole to come into contact with the latch upon rotation of the nozzle unit.

### BRIEF DESCRIPTION OF THE DRAWINGS

The above and other aspects, features and advantages of the invention will become apparent from the following detailed description in conjunction with the accompanying drawings, in which:

FIG. 1 is a partially cut-away perspective view of a dryer in accordance with one embodiment of the present invention;

FIG. 2 is a sectional view of the dryer of FIG. 1;

FIG. 3 is a cross-sectional view of a nozzle unit of FIG. 1; and

FIGS. 4 to 6 are perspective views illustrating a coupling procedure between a front supporter and the nozzle unit.

### DETAILED DESCRIPTION OF THE EMBODIMENTS

Embodiments of the invention will now be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

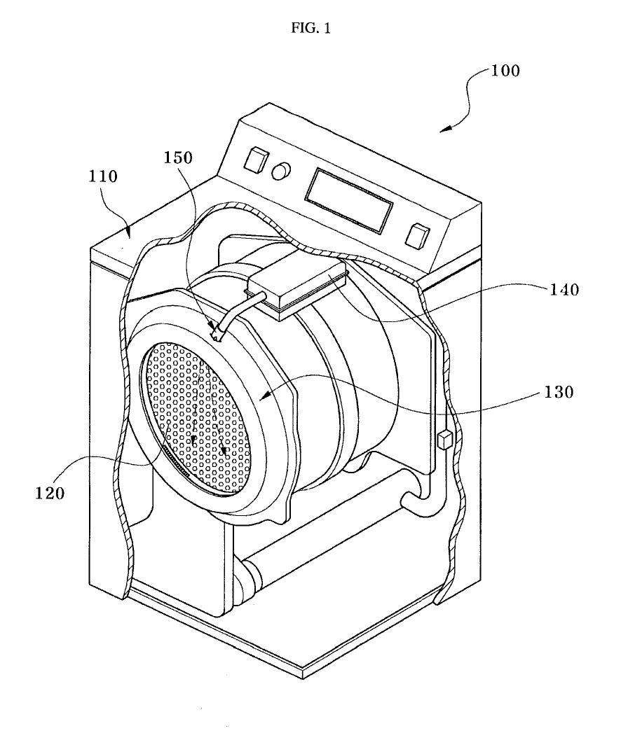

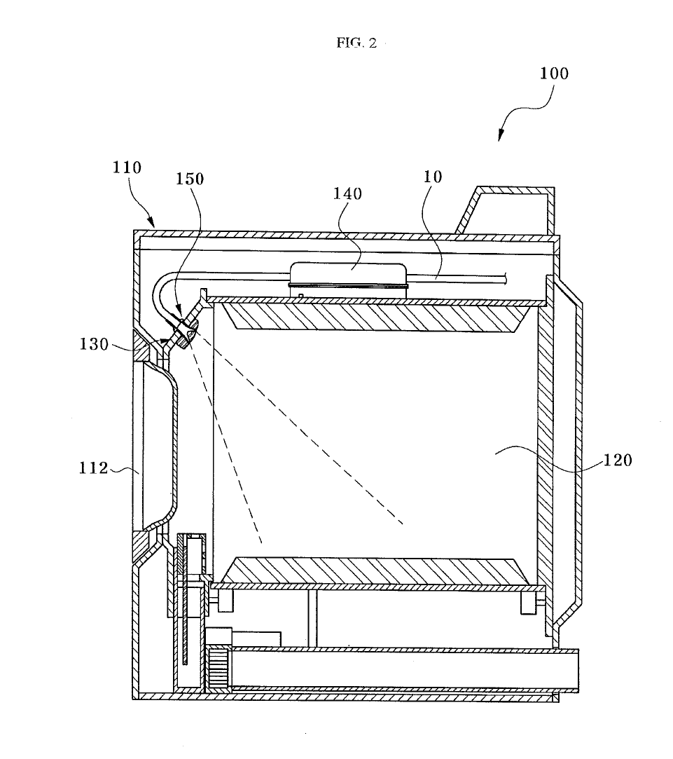

Referring to FIGS. 1 to 3, a dryer 100 according to one embodiment includes a cabinet 110, a drum 120, a front supporter 130, a steam generator 140, and a nozzle unit 150.

The cabinet 110 constitutes an outer appearance of the dryer 100 and defines a space therein. The cabinet 110 receives the drum 120 and other devices therein, and is provided with a water supply pipe 10 connected to an external water source.

The drum 120 is disposed inside the cabinet 110. The drum 120 receives laundry to be dried, such as clothes or the like, and is rotatably mounted inside the cabinet 110. The drum 120 is open at one side thereof.

The front supporter 130 is disposed at the open side of the drum 120, specifically between the open front side of the drum 120 and the door 112. The front supporter 130 is formed with an opening through which the drum 120 communicates with the outside of the dryer 100 and which is selectively opened or closed by the door 112.

The steam generator 140 is located inside the cabinet 110. The steam generator 140 is connected to the water supply pipe 10 and generates steam by heating water supplied from the water supply pipe 10. The steam generator 140 may include a housing which receives water from the water supply pipe 10, and a heater which is disposed in the housing and heats the water.

The nozzle unit 150 is coupled to the front supporter 130 and connected to the steam generator 140. The nozzle unit 150 sprays steam generated by the steam generator 140 toward plural regions within the drum 120. The nozzle unit 150 is coupled to an upper portion of the front supporter 130 and includes a first nozzle 152, a second nozzle 154, and a third nozzle 156.

The first nozzle 152 is connected to the steam generator 140. The first nozzle 152 is bifurcated into the second nozzle 154 and the third nozzle 156, which are formed within a body 153 constituting an end of the nozzle unit 150.

The second nozzle 154 is bifurcated from the first nozzle 152 and penetrates the front supporter 130 to spray steam in a first direction, for example, in a downward direction inside the drum 120 while being biased toward the front side of the drum 120.

The third nozzle 156 is bifurcated along with the second nozzle 154 from the first nozzle 152 and penetrates the front supporter 130 to spray steam in a second direction, for example, in the downward direction inside the drum 120 while being biased toward the center of the drum 120.

The nozzle unit 150 sprays the steam from the front inner side of the drum 120. As such, the nozzle unit 150 sprays the steam from the front inner side of the drum 120, thereby allowing the steam to be effectively delivered to laundry within the drum 120.

Considering a blowing direction of hot air from the rear side of the drum 120, the steam is sprayed in the same direction as the hot air when the steam is sprayed from the rear side of the drum 120, so that the steam can be directly discharged outside the dryer by the hot air instead of being suitably delivered to the laundry.

In this embodiment, however, the nozzle unit 150 sprays the steam in the downward direction inside the drum 120 from the front or upper side of the drum 120 to intersect the blowing direction of the hot air. Then, the steam can be uniformly sprayed to the laundry by air current resulting from rotation of the drum 120, so that the nozzle unit 150 of this embodiment enables the steam to be effectively delivered to the laundry within the drum 120.

Further, the nozzle unit 150 can spray the steam in several directions through the second and third nozzles 154, 156, so that the steam can be more effectively delivered to the laundry within the drum 120.

It should be noted that the nozzle unit 150 is described as being bifurcated into the second and third nozzles 154, 156 in this embodiment, but the invention is not limited thereto. For example, the nozzle unit 150 may also be bifurcated into three or more nozzles.

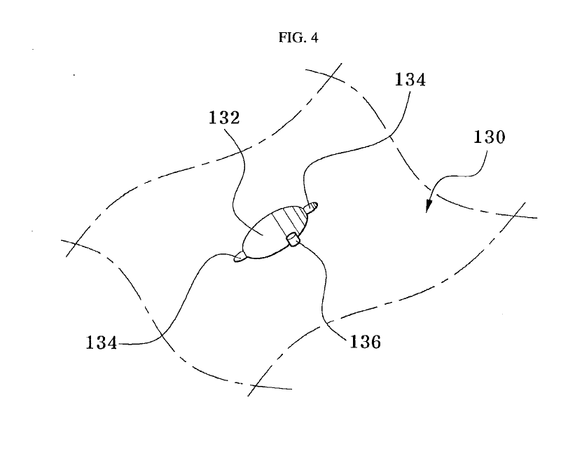

FIGS. 4 to 6 are perspective views illustrating a coupling procedure between a front supporter and the nozzle unit.

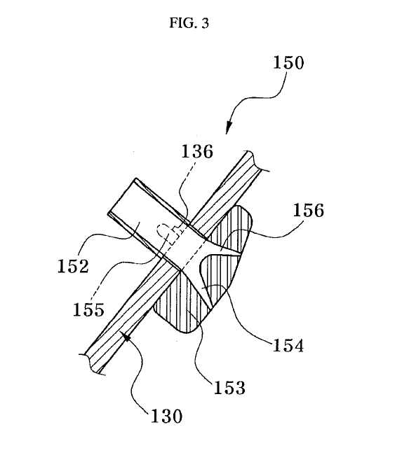

Referring to FIGS. 3 to 6, a coupling structure between the front supporter and the nozzle unit according to one embodiment will be described.

In this embodiment, as shown in FIGS. 3 and 4, the front supporter 130 is formed with an insertion hole 132 into which the nozzle unit 150 is inserted. Further, the front supporter 130 is formed with through-holes 134 extending from the insertion hole 132. Each of the through-holes 134 is formed to communicate with the insertion hole 132 such that a latch 155 protruding from an outer periphery of the first nozzle 152 passes through the through-hole 134 when the nozzle unit 150, specifically, the first nozzle 152, is inserted into the insertion hole 132.

The nozzle unit 150 is formed with the latches 155. Specifically, the latches 155 protrude from the outer periphery of the first nozzle 152.

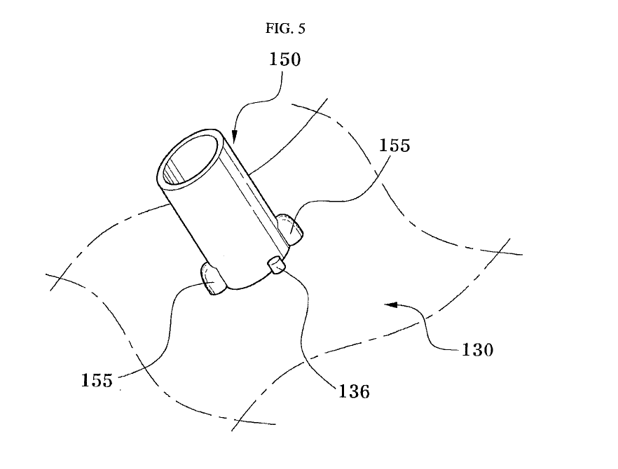

Referring to FIG. 5, the nozzle unit 150 is inserted from an inner side of the front supporter 130 into the insertion hole 132. When the nozzle unit 150 is completely inserted into the insertion hole 132, the latches 155 pass through the through-holes 134 and are located outside the front supporter 130.

A lower portion of the nozzle unit 150, that is, the body 153, has a greater size than the diameter of the insertion hole 132. This configuration prevents the nozzle unit 150 from being excessively inserted into the insertion hole 132 during insertion of the nozzle unit 150 into the insertion hole 132 and allows the nozzle unit 150 to be supported inside the front supporter 130 after the nozzle unit 150 is completely inserted into the insertion hole 132.

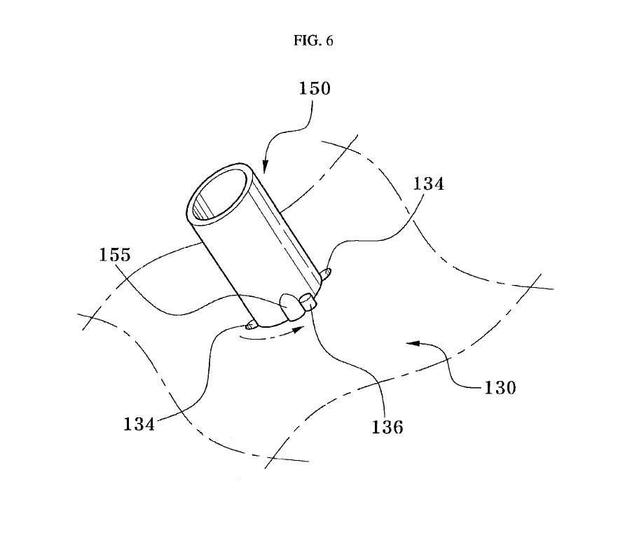

In this state, as shown in FIG. 6, when the nozzle unit 150 is rotated about 90 degrees, the latch 155 is brought into contact with a positioning protrusion 136, and the nozzle unit 150 is secured to the front supporter 130 by the body 153 and the latches 155, which are respectively located inside and outside the front supporter 130. For this structure, a distance between a lower surface of the latch 155 and an upper surface of the body 153 corresponds to the thickness of the front supporter 130.

The positioning protrusion 136 is formed on an outer periphery of the front supporter 130 to secure the nozzle unit 150 in place. The positioning protrusion 136 is formed adjacent to the outer periphery of the insertion hole 132 to catch the latch 155 when the nozzle 150 is rotated. The positioning protrusion 136 is disposed on the front supporter 130 to allow the second nozzle 154 to face in the aforementioned first direction and to allow the third nozzle 156 to face in the aforementioned second direction when the latch 155 is caught by the positioning protrusion 136. As a result, steam can be sprayed in the front downward direction and the central downward direction inside the drum 120 through the nozzle unit 150.

As such, according to the embodiments, the dryer supplies hot steam into the drum 120 so that the inner temperature of the drum 120 is rapidly increased, thereby enhancing drying efficiency. Further, the dryer can achieve sterilization of laundry as well as removal of wrinkles from the laundry.

Further, the dryer sprays steam in front of the drum while spraying the steam in several directions through the second and third nozzles, so that the steam can be very efficiently delivered to the laundry within the drum.

Although some embodiments have been provided to illustrate the invention in conjunction with the drawings, it will be apparent to those skilled in the art that the embodiments are given by way of illustration only, and that various modifications, changes, and substitutions can be made without departing from the spirit and scope of the present invention. The scope of the invention should be limited only by the accompanying claims.

What is claimed is:

1. A dryer comprising:
a cabinet;
a drum rotatably disposed inside the cabinet;
a front supporter disposed at an open side of the drum;
a steam generator disposed inside the cabinet and generating steam; and
a nozzle unit coupled to the front supporter and spraying the steam generated by the steam generator toward a plurality of regions inside the drum.

2. The dryer according to claim 1, wherein the nozzle unit is coupled to an upper portion of the front supporter.

3. The dryer according to claim 2, wherein the nozzle unit is bifurcated into plural nozzles.

4. The dryer according to claim 3, wherein the nozzle unit comprises a first nozzle connected to the steam generator, a second nozzle connected to the first nozzle and spraying the steam in a first direction, and a third nozzle connected to the first nozzle and spraying the steam in a second direction.

5. The dryer according to claim 4, wherein the first direction is a front direction of a lower portion of the drum and the second direction is a central direction of the lower portion of the drum.

6. The dryer according to claim 4, wherein the front supporter is formed with an insertion hole into which the nozzle unit is inserted.

7. The dryer according to claim 6, wherein the nozzle unit comprises a latch protruding from an outer periphery thereof, and the front supporter comprises a through-hole through which the latch of the nozzle unit passes when the nozzle unit is inserted into the insertion hole, the through-hole communicating with the insertion hole.

8. The dryer according to claim 7, wherein the nozzle unit comprise a body that has a greater size than a diameter of the insertion hole and supports the nozzle unit inside the front supporter.

9. The dryer according to claim 8, wherein the second nozzle and the third nozzle are formed within the body.

10. The dryer according to claim 8, wherein a distance between a lower surface of the latch and an upper surface of the body corresponds to a thickness of the front supporter.

11. The dryer according to claim 8, wherein the front supporter comprises a positioning protrusion formed on an outer periphery thereof to position the nozzle unit such that the second nozzle faces in the first direction and the third nozzle faces in the second direction.

12. The dryer according to claim 11, wherein the positioning protrusion is formed on an outer periphery of the insertion hole to come into contact with the latch upon rotation of the nozzle unit.
